(19) United States
(12) Patent Application Publication
(10) Pub. No.: US 2003/0141768 A1
(43) Pub. Date: Jul. 31, 2003

(54) Linear motor

(76) Inventor: Yong-yil Kim, Seoul (KR)

Correspondence Address: Steve Mun, Ste. H, 3400 De La Cruz Blvd., Santa Clara, CA, 95054-0067, US

(21) Appl. No.: 10/056,465

(22) Filed: Jan. 28, 2002

(51) Int. Cl. H02K 41/00

(52) U.S. Cl. 310/12

(57) ABSTRACT

A linear motor assembly includes opposing first and second magnet arrays; an elongated first yoke adapted to receive the first magnet array; an elongated second yoke adapted to receive the second magnet array; and a central magnet array positioned between the elongated first and second yokes, the central magnet array being adapted to slidably receive first and second coils on both sides of the central magnet array without a gap therebetween.

### BACKGROUND

This invention relates to a linear motor.

Linear motors offer many advantages, such as very high acceleration (up to 10 g) and sub-micron positioning accuracy, and can be ideal for new machinery or upgrades. Other benefits include having only one moving part, which leads to simplicity and reliability, with no backlash and high stiffness. Non-contact operation also reduces wear, giving long life and a reduction in maintenance. Linear motors are used in a variety of applications. For example, they are used in semiconductor manufacturing equipment, factory automation machinery, micro-lithographic instruments, and in other precision motion devices for precisely controlling the position of devices and instruments.

A conventional synchronous linear motor includes a magnet array that electromagnetically interacts with a coil array. Electromagnetic forces (called Lorentz forces) are generated on the coil array in cooperation with the magnet array, and the electromagnetic forces on the coil array cause the coil array to be propelled with respect to the magnet array, or vice versa. Thus, linear motors may incorporate a stationary magnet array (where the coil array is propelled) or a stationary coil array (where the magnet array is propelled). The coil array is typically mechanically secured to a translation stage (or carriage) that is slideably engaged with a set of rails.

Typically, a conventional moving coil type linear motor provides permanent magnets on both sides of a moveable coil assembly. The magnets are fixed on the inside surfaces of two rails so that they face each other. The magnets are mounted next to each other, each successive magnet having a pole orientation opposite that of the prior magnet.

The coil assembly is made of several coils potted into an epoxy plate. Each coil includes a wire that is wound around a generally rectangular frame with an opening in the center of the frame. The wire is wound in a direction perpendicular to the magnetic fluxes of the magnetic field created by the permanent magnets. A series of coils are placed adjacent each other and between the two opposing permanent magnet arrays. The wires wound on the coils intersect the flux lines between the opposing permanent magnet arrays, and an application of electricity to the wires creates a Lorentz force to move the coils.

FIG. 1 shows a conventional linear motor 10. The motor 10 includes a substantially U-shaped yoke 14 with two opposing magnets 16 mounted on the inside of the U-shaped yoke. The yoke 14 and the magnets 16 constitute a stator 17. A coil 18 is slidably positioned between the two opposing magnets 16 of the stator 17. One end of the coil 18 is secured to a mover support 20, which in turn is attached to a mover 22. The yoke 14 is fixedly secured to a support 12. Resting above an elevated portion of the support 12 is a linear motion guide 24. A second stator and coil assembly (not shown) can be provided to the right of the linear motion guide 24 to increase the force available to move loads on the mover 22. The entire assembly of the linear motor 10 is protected by cover portions 26. The bottom of the coil 18 rests above the bottom of the yoke 14 by a distance denoted as H1 which is typically twice the thickness of the yoke 14 due to the double folding of the yoke 14, while the bottom of the magnets 16 rests above the bottom of the yoke 14 by a distance denoted as H2.

FIG. 2 shows a second conventional linear motor 10′. The linear motor 10′ is essentially the same as the motor 10 of FIG. 1, with one difference being the existence of a second linear motion guide positioned such that the two linear motion guides 24R′ and 24L′ are on the outside of adjacent two stators 17R′ and 17L′. The stator 17R′ is separated from the stator 17R′ by a small distance 5. Since the two stators 17L′ and 17R′ are similar in assembly, only one will be discussed. The stator 17L′ includes a substantially U-shaped yoke 14L′ with two opposing magnets 16L′ mounted on the inside of the U-shaped yoke. A coil 18R′ is slidably positioned between the two opposing magnets 16R′ of the stator 17R′. The ends of the coils 18R′ and 18L′ are secured to a mover support 20′, which in turn is attached to a mover 22′. The yokes 14R′ and 14L′ are fixedly secured to a support 12′. The entire assembly of the linear motor 10′ is protected by cover portions 26′. The bottoms of the coils 18R′ and 18L′ rest above the bottom of the yokes 14R′ and 14L′ by a distance denoted as H1′, while the bottom of the magnets 16A′ and 16B′ rest above the bottom of the yoke 14′ by a distance denoted as H2′.

### SUMMARY

A linear motor assembly includes opposing first and second magnet arrays; an elongated first yoke adapted to receive the first magnet array; an elongated second yoke adapted to receive the second magnet array; and a central magnet array positioned between the elongated first and second yokes, the central magnet array being adapted to slidably receive first and second coils on both sides of the central magnet array without a gap therebetween.

Implementations of the linear motor assembly may include one or more of the following. The assembly can include an elongated central yoke positioned between the elongated first and second yokes. The central magnet array is positioned on a first face of the elongated central yoke. A means such as a bolt or epoxy secures the central magnet array to the first face. A second central magnet array is suitably positioned on a second face of the elongated central yoke. A base plate is coupled to the elongated first and second yokes; and the elongated central yoke is secured to the base plate. Each of the first and second magnet arrays comprises magnet elements being aligned in a row and positioned in alternating magnetic pole orientations. A mover can be connected to the first and second coils. A base plate can be connected to the elongated first and second yokes. A first support arm can be connected to the base plate, the support having a slot to slidably receive the elongated first yoke. Correspondingly, a second support arm is connected to the base plate, the support having a slot to slidably receive the elongated second yoke. The slot and the elongated first yoke can have interlocking trapezoidal shapes. The slot can be open-ended. A plate can close the open-ended slot and to secure the first yoke to the first support arm through a means for securing the plate to the slot. The securing means secures the plate horizontally or vertically. Further, one or more additional dual stator assemblies can be deployed in the motor, each having opposing third and fourth magnet arrays; third and fourth yokes adapted to receive the third and fourth magnet arrays; and a centrally positioned magnet array between the yokes. The magnet arrays includes at least eight magnets and wherein said magnetic flux path traverses through eight magnets in said single loop.

Advantages of the system may include one or more of the following. The linear motor is low-profile and compact. The double fold of the yoke is eliminated to reduce the motor height. Additionally, due to the support arms, the yoke does not need to be stiff and thus the thickness of the yoke can be reduced to reduce the motor width. In embodiments that eliminate the central yoke, motor width is further reduced.

The integrated dual stator assembly allows magnetic flux lines to flow through the entire yoke, entering and leaving the upper and lower edges of the yoke and flowing through all magnet arrays. This is in contrast to conventional linear motors where the flux lines enters and leaves opposing magnet arrays as one flux line set and enters and leaves opposing magnet arrays as another flux line set. Thus, to illustrate, magnetic flux flows through eight magnets rather than through four magnets as is done in conventional linear motors. The integrated dual yoke design allows the opposing magnet arrays to be moved close to each other to reduce magnetic flux path. The reduced distance increases flux density to support a powerful linear motor. The reduced distance also allows thin magnets to be used due to the path shape.

As an additional benefit, the dimensions of the motor allow the linear motor to be used in applications with size constraints. For applications that desire additional power, the motor can be scaled to stack more than two dual stator assemblies. In such cases, the magnets can be even thinner than the magnets of the dual motor subunits discussed above. The motor is also efficient and low in operating cost. It also is highly responsive to the demands of the application.

Other advantages and features will become apparent from the following description, including the drawings and claims.

### BRIEF DESCRIPTION OF THE DRAWINGS

FIG. 1 shows a conventional linear motor.

FIG. 2 shows another conventional linear motor.

FIG. 3 shows one embodiment of a linear motor in accordance with the invention.

FIG. 4 shows a perspective view of a yoke/magnet assembly of FIG. 3.

FIG. 5 shows another embodiment of a linear motor.

FIG. 6 shows yet another embodiment of a linear motor.

### DESCRIPTION

Referring now to the drawings in greater detail, there is illustrated therein structure diagrams for a linear motor. It will be understood that the motor's enhanced power is achieved through a coil assembly that stacks a number of coils in a configuration whose thickness is one coil thickness at the point where the coil assembly interacts with permanent magnet arrays. The motor's power is also enhanced by stacking motor sub-units in an integrated yoke, as will be more readily understood from a study of the diagrams.

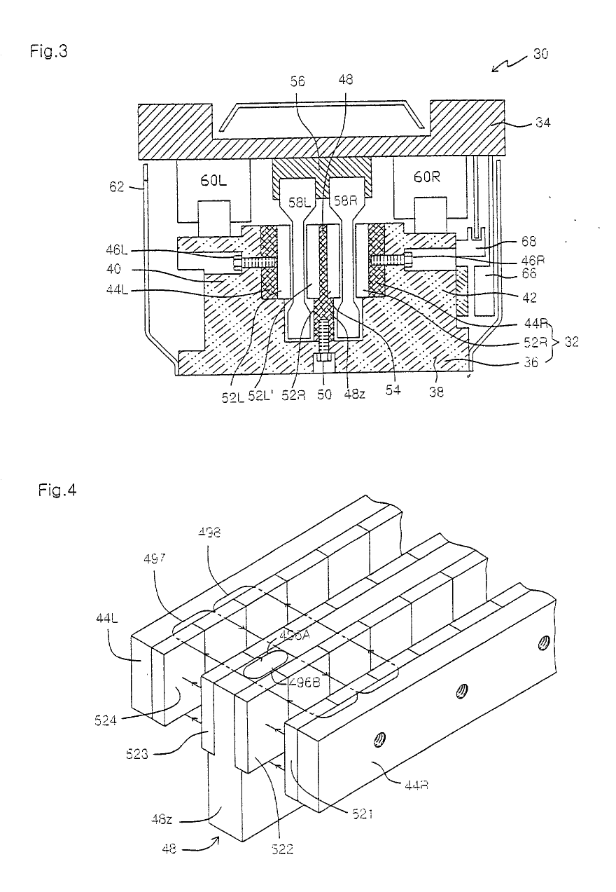

FIG. 3 shows one embodiment of a linear motor 30. The motor 30 has an integrated dual stator assembly that includes a left yoke 44L, a middle yoke 48 and a right yoke 44R. A magnet 52L is mounted on one side of the left yoke 44L and a opposing magnet 52L′ is mounted on one side of the middle yoke 48. Mounted on the other side of the middle yoke 48 is a magnet 52R′ that faces an opposing magnet 52R. The middle yoke 48 has an enlarged bottom 48z that receives a screw or bolt 50 to physically secure the middle yoke 48 to a base 38. The base can be aluminum granite, resin with granite powder, resin molded glass fiber, or resin molded Kevlar, or any weak magnetic material.

Extending from one side of the base 38 is a first upper support arm 40 with an opening to receive a bolt 46L. Similarly, extending from the other side of the base 38 is a second upper support arm 42 with an opening to receive a bolt 46R. The yokes 44L, 44R and 48, corresponding magnets 52R, 52R′, 52L and 52L′ and base 36 together define a stator 32. The bolts 46L and 46R clamp the left yoke 44L and the right yoke 44R of the integrated dual stator assembly, respectively, while the bolt 50 clamps the middle yoke 48, thus securing the yokes 44L, 44R and 48 of the integrated dual stator assembly to the stator 32. In contrast to the separate stator 17 and 17L′ and 17R′linear motor 10 and 10′, there is no gap between adjacent stator assemblies. The linear motor 30 is low-profile and compact. The double folds of the yokes 17L and 17R are eliminated to reduce the motor height. Additionally, due to the support arms, each yoke does not need to be stiff and thus the thickness of the yoke can be reduced to reduce the motor width.

Positioned between yokes 44L and 48 is a first coil 58L and positioned between yokes 48 and 44R is a second coil 58R. The coils 58R and 58L is secured to a coil support 56. The coil support 56 in turn engages a mover 34. A first linear motion guide 60L and a second linear motion guide 60R are positioned above the arms 40 and 42, respectively, and engage the mover 34. The linear motion guides or bearings 60L and 60R act as rails for the linear motor 30. The bearings 60L and 60R rest above elongated plates at the top of arms 40 and 42, respectively. The bearings 60L and 60R are sliding bearings that allow a load such as a carriage or stage to traverse a distance using the linear motor 30. In one embodiment, the mover 34 is U-shaped and a cover is positioned between the arms of the U-shaped mover 34.

The linear motor 30 includes a linear scale or encoder 66 and a limit sensor 68 mounted on one side of the motor 30. The entire motor assembly is protected by a cover 62. The encoder 66 senses the current position of the linear motor 401. Various types of position sensors can be used, including optical position sensor, resistive (potentiometric) position sensor, and magnetic position sensor (inductosyn). In an optical sensor, a movable code plate is made from a glass plate onto which chrome has been vapor deposited, or a metal plate, such as stainless steel, nickel, copper, or the like, and light transmitting sections are formed by etching in portions of ring-shaped regions scanned by a light-emitting element (LED) of a light source. The light source and a light receiving section are provided on either side of the movable code plate. The light source 1 and light receiving section are constituted respectively by a prescribed number of light-emitting elements (omitted from drawing) and photoreceptor elements. When a light transmitting section is positioned in front of the photoreceptor elements, light projected from the light source to the movable code plate is transmitted by the light transmitting section and enters the corresponding photoreceptor element, and a signal representing the received light is output by the photoreceptor element. A potentiometric sensor is essentially a voltage divider having a sliding contact which engages a carbon film strip or other electrically resistive means that is electrically connected to a supply voltage. The output voltage from the sensor is the voltage on the sliding contact or a proportion thereof. The position affects the position of the sliding contact relative to the resistive means, and so the value of the output voltage from the sensor can be used to provide an indication of the detected or measured position. The magnetic position sensor employs a plurality of square wave windings mounted on the surface of a stationary element, and a coil connected to an AC power source mounted on a movable element. The square wave windings each comprise a plurality of “high” and “low” parts and have different periods. The system determines the position of the movable element relative to the stationary element by detecting the variation in mutual inductance between the coil and the plurality of square wave windings. When the power source energizes the coil, a large current is induced in a square wave winding if the coil is adjacent a high part thereof. Only a small current is induced in a winding if the coil is adjacent a low part thereof. Therefore, the position of the movable element along the length of the stationary element can be determined from the signals on the windings.

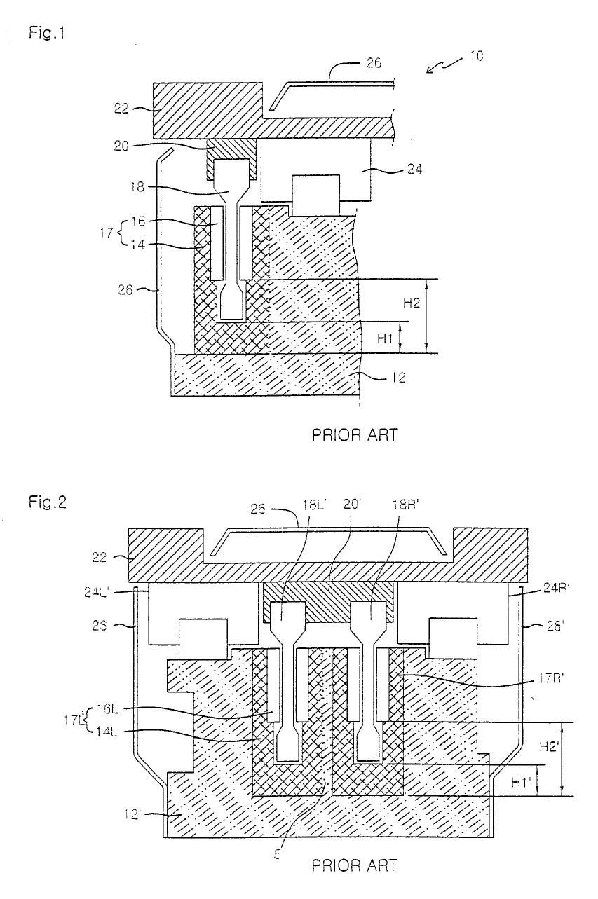

The structure of FIG. 3 is advantageous over the prior art exemplified in FIGS. 12 in several respects. First, the separate stators 17R′ and 17L′ of FIG. 2 are independent structures positioned slightly spaced apart from each other. The separate stators require more space. Further, the separate stators of FIGS. 1 and 2 experience two separate flux loops. When the thickness of the walls of each conventional stator is reduced, the opposing magnets would be attracted to each other and would distort the shape of the stators and would affect performance. In contrast, the structure of FIG. 3 experiences counteracting magnetic forces of the four magnet arrays and does not face such distortion. Further, the magnetic flux loop path length is reduced. Due to the reduced flux path, the magnet field strength is increased and motor power is enhanced. Additionally, due to the increased magnetic field, the magnet arrays 521-524 can be made thinner as well.

FIG. 4 shows a perspective view of one of the integrated yoke and magnet combinations in FIG. 3, in this case the integrated yoke 44 and magnet 52. The integrated dual yoke and magnet assembly includes yokes 44R, 48 and 44L. Mounted on one face of the yoke 44L is a permanent magnet array 524 of magnet strips having ends placed in an alternating north/south pole configuration. Mounted on a face of the yoke 48 opposing the magnet array 524 is a permanent magnet array 523 of magnet strips having ends placed in an alternating north/south pole configuration. Further, mounted on the other face of the yoke 48 is a permanent magnet array 522 of magnet strips having ends placed in an alternating north/south pole configuration. Mounted on a face of the yoke 44R opposing the magnet array 522 is a permanent magnet array 521 of magnet strips having ends placed in an alternating north/south pole configuration.

The yoke may be composed of a material having a high magnetic permeability and saturation level such as permalloy or supermalloy. The permanent magnet arrays 521-524 can include any number of permanent magnet strips, and alternating permanent magnet strips are arranged to have alternating polarities. In one embodiment, each of the magnetic strips in the permanent magnet strips have substantially the same width. The permanent magnet strips can be formed from any permanent magnet material, such as neodymium iron boron (NdFeB). The permanent magnet strips can be attached to the yokes 44R, 44L and 48 in any fashion, including glue or epoxy. Additional mechanisms for attaching permanent magnet strips to the yokes 44R, 44L and 48 include mechanical clamping and magnetic attraction. The magnets arrays are of uniform thickness so that their surfaces are a constant distance above surfaces of coil assemblies of an armature assembly (not shown). The magnets are designed to produce, along an axis of movement, a generally sinusoidal flux distribution for interaction with fields produced by the coil assemblies.

Substantially elongated coils 58R and 58L are positioned in the cavities. The coils 58R and 58L are wound in a direction perpendicular to the magnetic fluxes of the magnetic field created by the permanent magnets. When currents are applied to the coil array, a Lorentz force is generated and drives the mover 34 to move. More details of a specific embodiment of the yoke and coil can be found in co-pending application having Ser. No. 09/968,468, filed on Sep. 29, 2001 entitled “LINEAR MOTOR” to Yong-yil Kim, the content of which is hereby incorporated by reference. Other conventional coil and yoke can be used as well.

FIG. 4 shows exemplary magnetic flux lines 497 and 498 flowing through two magnetically alternating portions of the yokes 44L, 48 and 44R. The flux lines 497 and 498 have the same flux flow when they are adjacent each other. The flux lines 497 and 498 pass through the yokes 44L, 48 and 44R, entering and leaving the yokes 44L, 44R and 48 and flowing through all magnet arrays 521-524. For each stator portion, the single flux line across all magnets 521-524 reduces the flux path. The flux path is further reduced by eliminating the thick two piece housing of conventional sub-motors. This is in contrast to conventional linear motors with lengthened flux path due to the stacking of two separate motor housings and also due to the multiple flux line set. Further, the magnetic flux loop path length is reduced. For example, in the flux path 497, the width paths 496a and 496b (shown in dashed lines) are eliminated and the combined path 497 is shortened. Due to the reduced flux path, the magnet field strength is increased and motor power is enhanced. Additionally, due to the increased magnetic field, the magnet arrays 521-524 can be made thinner as well. Thus, by reducing flux path, flux strength is increased, resulting in a powerful motor.

The yoke and coil combination offers a high magnetic flux density and produces large forces for the linear motor. Moreover, although the exemplary motor 30 has only two stators 32, any arbitrary number of N stators can be stacked to increase motor power. In such stacking of N stators, the thickness of the magnets can be reduced since the flux path shape is shortened.

FIG. 5 shows one embodiment of a linear motor in which the opening on the first upper support arm 40a and its corresponding bolt (bolt 46L of FIG. 3) is eliminated. In the embodiment of FIG. 5, a yoke 44a with a cross-sectional dovetail shape is used. The dovetail-shaped cross-sectional yoke 44a has a first portion 45a with a width that is smaller than the width of a second portion 45b. The sides 45c and 45d slopes from the first portion 45a to the second portion 45b. In one embodiment, the cross-section of the yoke 44a is trapezoidal in shape. The invert of this embodiment can also be used where the first portion 45a is wider than the second portion 45b. A magnet 52a is secured to the first portion 45a using suitable epoxy or glue and faces a coil. The magnet 52a can have a trapezoidal cross-section as well, and the trapezoidal cross section can have a wide base and a short top or conversely the base can be short and the top of the magnet can be long. The yoke 44a dovetails with a corresponding groove 41a in the upper support arm 40a. During assembly, the magnet is attached to the yoke 44a and the resulting combination is inserted into the groove.

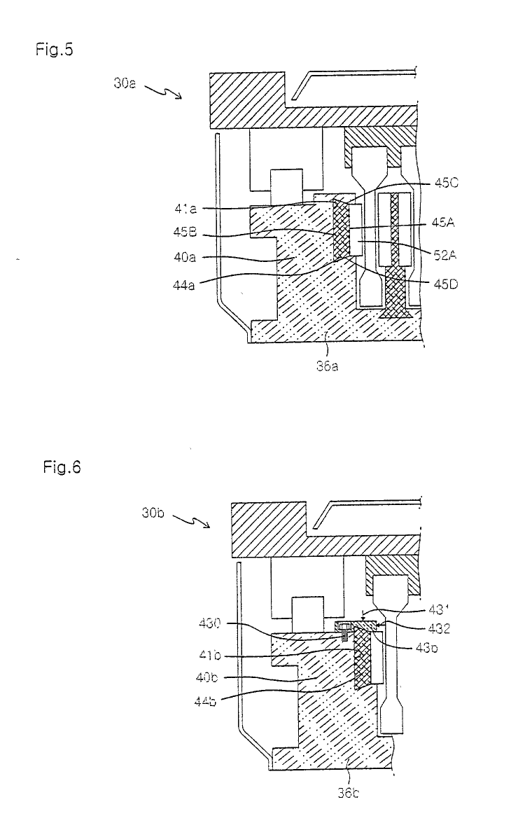

FIG. 6 shows another embodiment of a linear motor that does not require the bolt 46L of FIG. 3. In this embodiment, to minimize friction experienced when the magnet and yoke 44b combination is inserted into an upper arm 40b, the upper arm 40b has an open-ended groove 41b. During assembly, the magnet and yoke combination is placed in the open-ended groove 41b and a plate 43b is placed at the open end of the groove 41b. The plate 43b can be secured to the arm 41b using a bolt or screw 430. Alternatively, a screw can be placed at a spot 431 to vertically secure the plate 43b to the yoke 44b. Alternatively, a screw can be placed at a spot 432 to horizontally secure the plate 43b to the yoke 44b.

The invention has been described herein in considerable detail in order to comply with the patent Statutes and to provide those skilled in the art with the information needed to apply the novel principles and to construct and use such specialized components as are required. However, it is to be understood that the invention can be carried out by specifically different equipment and devices, and that various modifications, both as to the equipment details and operating procedures, can be accomplished without departing from the scope of the invention itself.

What is claimed is:

1. A linear motor assembly, comprising:
opposing first and second magnet arrays;
an elongated first yoke adapted to receive the first magnet array;
an elongated second yoke adapted to receive the second magnet array; and
a central magnet array positioned between the elongated first and second yokes, the central magnet array being adapted to slidably receive first and second coils on both sides of the central magnet array without a gap therebetween.

2. The linear motor assembly of claim 1, further comprising an elongated central yoke positioned between the elongated first and second yokes.

3. The linear motor assembly of claim 2, wherein the central magnet array is positioned on a first face of the elongated central yoke.

4. The linear motor assembly of claim 3, further comprising means for securing the central magnet array to the first face.

5. The linear motor assembly of claim 3, further comprising a second central magnet array positioned on a second face of the elongated central yoke.

6. The linear motor assembly of claim 5, further comprising means for securing the central magnet array to the second face.

7. The linear motor assembly of claim 3, further comprising a base plate coupled to the elongated first and second yokes; and means for securing the elongated central yoke to the base plate.

8. The linear motor assembly of claim 1, wherein each of said first and second magnet arrays comprises magnet elements being aligned in a row and positioned in alternating magnetic pole orientations.

9. The linear motor assembly of claim 1, further comprising a mover coupled to the first and second coils.

10. The linear motor assembly of claim 1, further comprising a base plate coupled to the elongated first and second yokes.

11. The linear motor assembly of claim 10, further comprising a first support arm coupled to the base plate, the support having a slot to slidably receive the elongated first yoke.

12. The linear motor assembly of claim 11, further comprising a second support arm coupled to the base plate, the support having a slot to slidably receive the elongated second yoke.

13. The linear motor assembly of claim 10, wherein the slot and the elongated first yoke have interlocking trapezoidal shapes.

14. The linear motor assembly of claim 10, wherein the slot is open-ended.

15. The linear motor assembly of claim 14, further comprising a plate to close the open-ended slot and to secure the first yoke to the first support arm.

16. The linear motor assembly of claim 15, further comprising means for securing the plate to the slot.

17. The linear motor assembly of claim 16, wherein the securing means secures the plate horizontally or vertically.

18. The linear motor assembly of claim 1, further comprising one or more additional dual stator assemblies, each comprising opposing third and fourth magnet arrays; third and fourth yokes adapted to receive the third and fourth magnet arrays; and a centrally positioned magnet array between the yokes.

19. The linear motor assembly of claim 1, wherein said magnet arrays includes at least eight magnets and wherein said magnetic flux path traverses through eight magnets in said single loop.

20. A linear motor, comprising:
first and second coil assemblies, each coil assembly formed from a plurality of coils;
opposing first and second magnet arrays;
an elongated first yoke adapted to receive the first magnet array;
an elongated second yoke adapted to receive the second magnet array; and
a central magnet array positioned between the elongated first and second yokes, the central magnet array being adapted to slidably receive the first and second coils on both sides of the central magnet array without a gap therebetween.
